(19) United States
(12) Patent Application Publication
(10) Pub. No.: US 2010/0074860 A1
(43) Pub. Date: Mar. 25, 2010

(54) INSECT ATTRACTANT FORMULATIONS

(75) Inventors: Kenneth J. Kupfer, Nokomis, FL (US); Robert E. McManus, Nokomis, FL (US)

Correspondence Address: GIFFORD, KRASS, SPRINKLE,ANDERSON & CITKOWSKI, P.C, PO BOX 7021, TROY, MI, 48007-7021, US

(73) Assignee: KM Investors LLC, Nokomis, FL (US)

(21) Appl. No.: 12/525,340

(22) PCT Filed: Jan. 30, 2008
(86) PCT No.: PCT/US08/52487

§ 371 Date: Jul. 31, 2009

Related U.S. Application Data
(63) Continuation of application No. 11/995,631, filed on Jan. 14, 2008.
(60) Provisional application No. 60/898,623, filed on Feb. 1, 2007.

(30) Foreign Application Priority Data
Dec. 3, 2007 (US) PCT/US2007/086253

(51) Int. Cl. A01N 25/00; A01P 19/00

(52) U.S. Cl. 424/84

(57) ABSTRACT

Disclosed are insect attractants in dry powdery formulations that when mixed with or used in cooperation with pre-registered, commercially-available, active ingredients and solvents, form low-toxicity, environment-friendly, baiting systems to attract and kill or otherwise neutralize a broad range of crop-damaging, crawling, walking and flying insects.

### CROSS-REFERENCE TO RELATED APPLICATIONS

The present application claims priority to U.S. Provisional Patent Application Ser. No. 60/898,623 filed Feb. 1, 2007. The present application is also a continuation-in-part of copending PCT Patent Application Serial No. PCT/US07/86253 filed Dec. 3, 2007 which claims priority to U.S. Provisional Application Ser. No. 60/872,632 filed Dec. 4, 2006; and a continuation-in-part application of U.S. application Ser. No. 11/995,631 filed Jan. 14, 2008 which is a '371 national phase of PCT Patent Application Serial No. PCT/US2008/050217 filed Jan. 4, 2008 claiming priority to U.S. Provisional Patent Application Ser. No. 60/879,060 filed Jan. 8, 2007. The contents of each are incorporated herein by reference.

### FIELD OF THE INVENTION

This invention relates to the field of pest control, and more particularly to insect attractants in dry powdery formulations that when mixed with, or used in cooperation with pre-registered, commercially-available, active ingredients and solvents, form low-toxicity, environment-friendly, baiting systems for utilization of weather-sheltered, liquid bait station dispensers to attract and kill or otherwise neutralize a broad range of crop-damaging, crawling, walking and flying insects.

### BACKGROUND OF THE INVENTION

Applicants of the instant application have previously described a Dry Powder Formulation for Low-Toxicity Insect Bait in U.S. patent application Ser. No. 11/537,772 filed on Oct. 2, 2006 and in co-pending PCT Application Ser. No. PCT/US 06/38695 filed Oct. 3, 2006 for use in cooperation with the Liquid Gravity Feed Elimination System (LGFAES) dispenser detailed in U.S. Pat. No. 6,467,216 B2, issued Oct. 22, 2002, the entire content of which is now incorporated herein by reference.

The LGFAES dispenser, with its weather-sheltering, long-term delivery attributes, permits the use of slow-acting, low-toxicity liquid baits whereby the foraging insects after consuming, or otherwise being contaminated with the bait, leave the dispenser to die and, in many instances, share this bait or its effect with other like insects thus contributing to the destruction of the total problem infestation. In addition, since the liquid attractant and bait is stored and provided to the targeted feeding insects entirely within the dispenser, this total insect infestation elimination is accomplished in a bio-rational manner. Alternate delivery methods using quick-acting, high-toxicity baits kill the foraging insects prior to their contact with other insects of the same species, or other species, and fail to adversely affect their population. With some insect species, the quick killing action causes stress in the other members of their colony and causes them to repopulate in greater numbers. In addition, the broadcast delivery of bait kills beneficial insects and contributes to contamination of the environment. The design of insect attractant formulations to be mixed with low-toxicity active ingredients, commercially available, provides liquid baits that are focused to attract and kill specific noxious insects, with delivery from weather-sheltered, self-contained dispensers. It provides a readily available source of proven designer baits; permitting their use by all growers including organic growers, and allowing the concurrent use of beneficial insects in the control of a broad spectrum of insect species.

An embodiment of the insect attractant compound of the present invention is comprised of an attractant of floral odor, pheromone, plant extract, a sugar, honey, molasses, a protein, or combinations of amino acids in varying amounts; or other attractants adaptable to the distinct, targeted insect species. A food substance comprised of a plant extract, a sugar, honey, molasses, a protein, or combinations of amino acids in varying amounts; a buffer comprised of an acid or alkaloid to adjust bait to desired ph. Sodium benzoate, citric acid, ascorbic acid, borate or other preservatives will be present in varying amounts to inhibit bait degradation and bacteria growth. A combination of one or more adjuvants such as an antioxidant to increase stability and prolong life of bait; a synergist such as piperonyl butoxide to delay remedial enzyme action in insects; and a trail pheromone or sex pheromone to enhance the effectiveness of the active ingredient and or the attractant, thereby reducing total ingredients by weight required, thus assisting in placing said bait ingredients into solution without precipitate. The attractant concentrate is placed in solution when diluted with water, vegetable oil, alcohol, petroleum distillate or other solvent.

### DESCRIPTION OF PRIOR ART

U.S. Pat. No. 6,916,469 discloses a gellable ant bait matrix comprising protein, carbohydrate, fat, and sterol as ant-preferred nutrients and uric acid as a bait-enhancing agent. The gellable matrix offers the benefit of its ability to apply the bait in cracks and areas not normally accessible to ant baiting systems. Methods of making ant-preferred matrices of this reference are also provided comprising mixing the various components to form a food.

U.S. Pat. No. 5,928,634 discloses a liquid bait for target insects and methods of attracting or controlling insects by means of its use. This reference specifically discloses the addition of sorbitol as a humectant to retard the drying of the liquid bait. The liquid bait further includes at least one insect attractant that is selected from the group consisting of sucrose, fructose, d-maltose, the lithium salt of saccharin, lithium chloride, and vitamins.

U.S. Pat. No. 5,939,061 discloses an attractant composition for the control of multiple species of pest arthropods, particularly multiple species of pest ants. The composition, which includes a sugar and a salt for base, and water, attracts both oil-loving and sweet-loving ants and is especially useful with water soluble or suspendable toxicants.

U.S. Pat. No. 5,871,780 discloses a pest-controlling composition comprising a borate compound and a compound resulting in elevated concentrations of cyclic AMP, such as a phosphodiesterase enzyme inhibitor, or a formamidine. The borate compound of the pest-controlling composition has increased toxicity as compared to a borate compound acting alone.

### SUMMARY OF THE INVENTION

According to the present invention, there is provided an insect-attracting compound comprising an attractant, a food substance, a buffer, a preservative, and one or more adjuvants.

It is an objective of the present invention to provide an attractant compound that when mixed with a pre-registered, commercially-available, active ingredient and solvent, form a low-toxicity liquid bait focused to attract and kill or otherwise neutralize specific crop-damaging or otherwise problem insects for use by organic growers and other environment-sensitive end-users.

It is another objective of the present invention to reduce the need for the indiscriminate broadcast delivery of insecticides by designing a number of attractant formulas for mixing with a variety of pre-registered, commercially available active ingredients for the elimination of a broad range of noxious, crawling, walking and flying insects in an environment-friendly manner.

It is another objective of the present invention to create an attractant compound that when mixed with a commercially-available active ingredient and a solvent, provides a bait to the targeted insects on an continuous, uninterrupted basis; as contrasted with the broadcast delivery method, where similar active ingredients might be restricted to broadcast delivery once or twice a year, and after application, the baits unfavorable affect beneficial insects, cause pesticide run-off into the environment and are subject to rapid dissipation of effectiveness because of the sun, rain and other such elements.

It is another objective of the present invention, when mixed with a commercially available active ingredient and a solvent, to permit and promote the concurrent use of beneficial insects in the control of a broad spectrum insect species.

It is another objective of the present invention, when mixed with a commercially-available active ingredient and a solvent, is to provide a delayed kill or neutralizing of the insect in order to create the opportunity to unfavorably affect the targeted insect population, as apposed to rapid kill of the foraging insects, only;

It is another objective of the present invention is to provide an insect-attractant compound designed, manufactured, packaged, shipped and otherwise handled in a dry powdery form prior to being mixed with an active ingredient and completely dissolved with water or other solvent by agricultural growers or other end users as means to greatly increase the flexibility in the use of readily available active ingredients and reduce the bait's volume and weight and related cost to produce and handle prior to its final use.

It is another objective of the present invention is to provide an insect-attractant composition designed, manufactured, combined with a commercially-available active ingredient; prior to being packaged and shipped as a powdery bait to be completely dissolved with water or other solvent by agricultural growers or other end users; thusly accommodating the end user that does not have easy access to the required commercially available active ingredient or that wishes the convenience of using a premixed powdery bait formulation.

It is another objective of the present invention, when mixed with a commercially-available active ingredient and a solvent, is to provide an insect-controlling composition in a solution without precipitate that is compatible to be used in concert with the gravity-feed, long-term delivery, Liquid Gravity Feed Elimination System (LGFAES) or similar device.

It is another objective of the present invention to produce attractant formulations that are compatible with the effective utilization of commercially available and pre-registered, active ingredients including fiprinil, imidacloprid, spinosads, borates, sterilizing agents, growth inhibitors, pheromones, virus, bacteria, fungus, parasites or any combination thereof. The pre-registration includes government approval for use in the control of the targeted insect within the targeted environment.

It is another objective of the present invention to provide an attractant compound that when mixed with a solvent provides a means of utilizing the LGFAES gravity-feed dispensing system in cooperation with the insect contamination band-type device disclosed in Applicant's copending PCT Application Ser. No. PCT/US 2008/050217 filed Jan. 4, 2008. Commercially available, active ingredients, including fungus or similar pathogen-like material, can be impregnated into the contamination band shown in this application, operate with the species specific insect attractants in the middle ring feeding pool of the LGFAES, to provide the means to contaminate foraging insects with these active ingredients.

These and other objectives become apparent from the following description of preferred embodiments taken together with the appended claims.

### DETAILED DESCRIPTION OF THE PREFERRED EMBODIMENTS

As used herein, the terms “bait” and “attractant” mean any substances that entice an insect to ingest, or come in contact with, that substance alone, or combined with one or more other substances, including an insect toxicant or other active ingredient.

As used herein, the term “growth inhibitor” means any of the endogenous or exogenous substances that inhibit the normal growth of animals, insects, plants, fungi, or their tissues, or the growth of microorganisms.

The present invention, when mixed with, or used in cooperation with, a commercially-available active ingredient and a solvent, is described as a formulation for use by the growers or other end users to produce a low-toxicity, bio-rational, insecticidal baiting system for controlling many crawling, walking and flying insects pest.

In one embodiment, the bait composition in the present invention, when mixed with a commercially-available active ingredient and solvent, comprises a borate component which is at a ratio of 2% or less by percentage weight to the finished bait total volume. The borate component is selected from the group of active ingredients including fiprinil, imidacloprid, spinosads, borates, sterilizing agents, growth inhibitors, pheromones, virus, bacteria, fungus, parasites or any combination thereof. The bait composition further comprises a combination of attractants, food substance, buffer, preservatives, and adjuvants. The attractant includes floral odor, pheromone, a plant extract, a sugar, honey, molasses, a protein, or combinations of amino acids in varying amounts; or other attractants adaptable to multiple insect species to attract insects to consume or otherwise be exposed to the active ingredients. The food substance includes a plant extract, a sugar, honey, molasses, a protein, or combinations of amino acids in varying amounts; or other fluid or material adaptable to be ingested by multiple insect species The buffer is comprised of an compatible acid or alkaloid or a combination thereof to adjust bait to desired ph. The preservative includes, but are not limited to, sodium benzoate, borate, ascorbic acid and citric acid. The preservative is present in various amounts to inhibit bait degradation and bacteria growth. The adjuvant assists in increasing the effectiveness of the active ingredient and the attractant, and aids in placing all of the above ingredients in solution with little or no precipitation so as to improve solubility of the bait composition.

The attractant composition within the present invention is exclusive of any active ingredient or liquid component. More specifically, the attractant composition is presented with a dry powder formulation. The attractant composition within the present invention is neither a gel matrix nor a liquid.

The attractant composition within the present invention is formulated as an insect attractant concentrate. When mixed with an active ingredient and dissolved in water, vegetable oil, alcohol, petroleum distillate or other solvents, the attractant concentrate changes into a liquid bait, without precipitate, suitable for use in the gravity-feed, long-term delivery, LGFAES dispenser system or equivalent.

Several advantages are obtained by providing a attractant composition for combining with a commercially available active ingredient and solvent, and feeding the insects within a self-contained dispenser. Among these advantages are: avoids the broadcast delivery of pesticides that indiscriminately kills beneficial insects and pollutes the environment; provides for continuous season-long insect control rather than to the 1-2 times broadcast delivery allowed; permits utilizing an attractant and active ingredient designed to kill, or otherwise neutralize, the targeted insects, only; allows for the use of a pre approved and readily available active ingredient; allows beneficial insects to be used concurrently in the control of a broad spectrum insect species; permits the bait's use by organic growers; and encourages its use by environment sensitive growers.

The attractant composition within the present invention, when mixed with a commercially-available active ingredient and solvent, is applicable to be used with the LGFAES Station Dispenser (U.S. Pat. No. 6,467,216). The LGFAES dispenser provides a low-maintenance, weather-resistant ant elimination system via a practical, safe mechanical liquid delivery platform designed for use with a low-toxicity liquid insect bait. The LGFAES dispenses a controlled amount of low toxic liquid bait from an air-restricted reservoir over an extensive period of time so as to reduce liquid bait degradation due bacteria growth, dead insect and plant contamination and loss due to evaporation. With the combined application of the LGFAES Station Dispenser and the bait prepared as a result of the present invention, the foraging insects after consuming, or otherwise being contaminated with the bait, leave to die or become neutralized and, in many instances, share this bait or its effect with other targeted insects thus contributing to the destruction of the total problem infestation In addition, since the liquid bait stored and provided to the foraging ants is entirely within the Dispenser, the elimination of the infestation is accomplished in a most bio-rational manner.

Another embodiment of the insect attractant compound being discovered, after mixing with a solvent, is its use within the LGFAES gravity-feed dispensing system in cooperation with the insect contamination band-type device located outwardly adjacent to the middle ring feeding pool of the LGFAES. Commercially available, active ingredients including fungus or similar pathogen-like material impregnated into the contamination band, operating with the species specific insect attractants in the feeding pool, contaminate foraging insects with these active ingredients and provide the insects as a means to transfer these materials to infect or otherwise affect other insects, when the foragers leave to mate with, feed or to otherwise be in contact with other insects of the same species; or be in contact with other insects of a different species as in the case of the Argentine or similar ants, when they are protecting or harvesting the honeydew of the mealy bugs, aphids and other such homoptera.

It is another objective of the present invention is to produce attractant formulations that are compatible with the effective utilization of commercially available and pre-registered, pyrthroid, which is used for the control of a broad range of problem insects, including ticks, fleas, bed bugs, mealy bugs, aphids and whiteflies.

It is another objective of the present invention is to produce attractant formulations that are compatible with the effective utilization of commercially available and pre-registered, imidacloprid that is used for the control of a broad range of problem insects, including tobacco flea beetle, Colorado potato beetle, glassy-winged sharpshooter, citrus leaf miner, mealy bugs, aphids and whiteflies.

### EXAMPLE 1

A dry powdery attractant composition, after combining with Solubor, a disodium octoborate tetrahydrate based active ingredient, made commercially available by U.S. Borax, used for the control of a broad range of problem ants, including Argentine ants, carpenter ants, fire ants, white-footed ants and big headed ants, comprises the following ingredients by percentage weight to finished bait total volume:
1.0% disodium octoborate tetrahydrate
12.5% fructose and 12.5% sucrose as an attractant;
2% citric acid as a buffer to lower the ph;
0.5 sodium benzoate as a preservative; and
An as needed amount of trail pheromone to supplement the attractant as an adjuvant.

### EXAMPLE 2

A dry powdery attractant composition, used in cooperation with Mycotrol O®, a beauveria bassiana strain GHA (fungus) based active ingredient, made commercially available by Mycotech Corporation, and used for the control of a broad range of problem insects, including sod webworm, fire ants, Japanese beetles, mealy bugs, aphids and whiteflies that is impregnated into the insect contamination band, comprises the following ingredients by percentage weight to finished attractant total volume:
12.5% fructose and 12.5% sucrose as an attractant;
0.4% plant extract as a food substance;
2% citric acid as a buffer to lower the ph;
0.5 ascorbic acid as a preservative; and a floral odor of the targeted plant to supplement the attractant as an adjuvant.

It should noted that the above compound is used to attract the Argentine or similar ants to the dispenser so that the above noted fungus becomes attached to their body when they pass over the contamination band, and then leave to transfer this active ingredient as these ants go on to protect or harvest the honeydew of the mealy bugs, aphids and other such homoptera.

It should be apparent that the present invention provides a method of producing a attractant formulation that can be premixed with a commercially available active ingredient in the manufacturing process or that can be combined with said active ingredient by the end user, prior to mixing with a solvent to produce a low-toxicity, bio-rational, insect bait, without precipitate, that can be used in the LGFAES liquid bait station dispenser, or equivalent. Most liquid insect baits now sold are highly toxic mixtures, primarily colloidal suspensions that are designed for the quick kill of the foraging insects, prior to dissipation of the bait by the sun, rain and other elements, and not to cause exponential damage to the entire targeted insect infestation. The attractant composition as presently disclosed, when combined with a commercially available active ingredient and a solvent is without precipitate so as not to interrupt the LGFARES dispensing action. And it also includes a preservative that inhibits bait degradation and bacteria growth.

Also, it should be apparent that the present invention provides a method of producing an attractant formulation that can be used in cooperation with an insect contamination band-type device impregnated with a commercially available active ingredients to contaminate foraging insects with these active ingredients and provide the foragers as a means to transfer these materials to infect or otherwise affect other insects.

While the foregoing description provides specific embodiments of the present invention, it should be appreciated that these embodiments are described for the purposes of illustration only, and that numerous alterations and modifications may be practiced by those skilled in the art without departing from the spirit and scope of the invention. It is intended that all such modifications and alterations be included insofar as they come within the scope of the invention as claimed or the equivalent thereof.

1. An insect attractant composition in the form of dry powder, comprising:
an attractant,
a food substance,
a buffer,
a preservative,
an adjuvant, and
said insect attractant operates in conjunction, and is compatible for use with insect-killing agents comprising pyrthroid, imidacloprid, fiprinil, spinosad, borate, sterilizing agent, mating disruptor, pheromone, fungus, virus, bacteria, parasite or any combination thereof.

2. The insect attractant composition of claim 1 and in which said insect attractant operates in conjunction, and is compatible for use, with a variety of commercially available active ingredients taken from the group including Mycotrol O®, a beauveria bassiana strain GHA (fungus) based active ingredient and Solubor, a disodium octoborate tetrahydrate based active ingredient

3. The insect attractant composition of claim 2 combined with an insect-killing agent that is disodium octoborate tetrahydrate, in a concentration range of 1.0% to 0.5% by percentage weight to finished bait total volume.

4. The insect attractant composition of claim 2, operating in combination with an insect-killing agent that is beauveria bassiana, a fungus, impregnated into an insect contamination band-type device, is in a concentration range of 1.0% to 2.0% by percentage weight to finished bait total volume.

5. The insect attractant composition of claim 1, wherein said attractant comprises a floral odor, pheromone, a plant extract, honey, molasses, glucose, a fructose, a maltose, a sucrose, a protein, an amino acid, or any combination thereof.

6. The insect attractant composition of claim 5, wherein said attractant consists of 12.5% fructose and 12.5% sucrose by percentage weight to finished bait total volume.

7. The insect attractant composition of claim 1, wherein said food substance comprises a plant extract, honey, molasses, glucose, a fructose, a maltose, a sucrose, a protein, an amino acid, or any combination thereof.

8. The insect attractant composition of claim 7, wherein said food substance comprises a range of 0.1% to 0.5% plant extract by percentage weight to finished bait total volume.

9. The insect attractant composition of claim 1, wherein said buffer comprises a range of 1.0% to 2.0% citric acid by percentage weight to finished bait total volume.

10. The insect attractant composition of claim 1, wherein said preservative comprises a sodium benzoate, a citric acid, ascorbic acid, disodium octoborate, or any combination thereof.

11. The insect attractant composition of claim 10, wherein said preservative is sodium benzoate in the range of 0.1% to 0.3% by percentage weight to finished bait total volume.

12. The insect attractant composition of claim 10, wherein said preservative is ascorbic acid in the range of 0.5% to 1.0% by percentage weight to finished bait total volume.

13. The insect bait of claim 1, wherein said adjuvant is an antioxidant; a synergist such as piperonyl; a trail pheromone or a sex pheromone; or other material to assist placing said bait ingredients into solution without precipitate.

14. The insect bait of claim 13, wherein said adjuvants are an as needed amount of trail pheromones.

15. The insect bait of claim 13, wherein said adjuvants are an as needed amount of plant floral odor.

16. An insect attractant composition in the form of dry powder, comprising:
an attractant,
a food substance,
a buffer,
a preservative, and
an adjuvant.
said insect attractant operates in conjunction, and is compatible for use, with a variety of commercially available active ingredients taken from the group including Mycotrol O®, a beauveria bassiana strain GHA (fungus) based active ingredient and Solubor, a disodium octoborate tetrahydrate based active ingredient.
